(19) United States
(12) Patent Application Publication
(10) Pub. No.: US 2024/0030691 A1
(43) Pub. Date: Jan. 25, 2024

(54) CABLE CLASPING DEVICE

(71) Applicant: AICHELE AND ASSOCIATES, LLC, Brentwood, TN (US)

(72) Inventor: Natalie AICHELE, Brentwood, TN (US)

(21) Appl. No.: 18/341,910

(22) Filed: Jun. 27, 2023

Related U.S. Application Data
(63) Continuation-in-part of application No. 17/868,592, filed on Jul. 19, 2022.

(51) Int. Cl. H02G 3/32; H02G 3/04

(52) U.S. Cl. CPC H02G 3/32; H02G 3/0418; H02G 3/045

(57) ABSTRACT

A cable clasping device includes a body and a mounting system. The body defines an outer surface, a first end face, a second end face, and one or more retention structures configured to receive a section of a cable to retentively secure the section of the cable with respect to the body. The retention structures define an indentation extending into a thickness of the body from the outer surface and spanning between the first end face and the second end face to facilitate the section of the cable to be accommodated and routed through the body. The mounting system is configured to mount the body against a surface to retain the section of the cable against the surface.

### CROSS REFERENCE TO RELATED APPLICATIONS

The present application is a continuation-in-part of U.S. Non-Provisional application Ser. No. 17/868,592, filed Jul. 19, 2022, entitled “CABLE CLASPING DEVICE,” which is incorporated by reference herein in its entirety.

### BACKGROUND OF THE INVENTION

It is a common practice for cords and cables (for example an electrical cable) to be left hanging freely from an apparatus or a device, such as an electrical device, whether or not the apparatus or the device is in use. Such loose cords can be a safety hazard. A mishandling of a dangling cable (for example, by fiddling with the dangling cable or by purposefully or accidently pulling the dangling cable) can result in substantial misplacement and movement of the cord and consequently movement of the connected device, possibly resulting in damage to the device, a fire hazard, or harm to a person or other living being.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIGS. 1A and 1B are pictorial views illustrating exemplary applications of cable clasping devices, in accordance with some embodiments;

FIGS. 2A through 2E are close up views of the cable clasping device of FIG. 1A illustrating exemplary structural and configurational details of said cable clasping device, in accordance with some embodiments;

FIGS. 3A through 3D are plan views illustrating exemplary variations in the structural and configurational details of said cable clasping device of FIG. 1A, in accordance with some embodiments;

FIGS. 4A and 4B are plan views illustrating other exemplary variations in the structural and configurational details of said cable clasping device of FIG. 1A, in accordance with some embodiments;

FIGS. 5A through 5D are isometric views that illustrate an exemplary mounting system of the cable clasping device of FIG. 1A, in accordance with some embodiments;

FIGS. 6A and 6B are views of an exemplary lever applicable with the exemplary mounting systems of FIGS. 5A through 5D, in accordance with some embodiments;

FIGS. 7A and 7B are views of another exemplary mounting system applicable with the cable clasping device of FIG. 1B, in accordance with some embodiments;

FIGS. 8A and 8B are a set of pictorial views illustrating exemplary applications of another embodiment of a cable clasping device;

FIGS. 9A and 9B are various close up views of the cable clasping device of FIGS. 8A and 8B, illustrating exemplary structural and configurational details of said cable clasping device, in accordance with some embodiments;

FIGS. 10A through 10D are views that correspond to yet another cable clasping device and its exemplary use in clasping a section of a cable therewithin, in accordance with some embodiments;

FIGS. 11A through 11C are plan views illustrating exemplary variations in structural details of a retention structure or an indentation defined by bodies of one or more of the cable clasping devices of FIGS. 9A through 10D, in accordance with some embodiments; and

FIGS. 12A and 12B are views of still another embodiment of the cable clasping devices of FIGS. 9A through 10D.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments.

The apparatus and method components have been represented where appropriate by conventional symbols in the drawings, showing only those specific details that are pertinent to understanding the embodiments so as not to obscure the description with details that will be readily apparent to those of ordinary skill in the art having the benefit of the description herein.

### DETAILED DESCRIPTION OF THE INVENTION

The embodiments described herein are related to a cable clasping device that facilitates retention of a section of a cable against a surface so as to prevent misplacement of the cable with respect to the surface. The cable can extend from an apparatus (for example, an electrical appliance), and, therefore, along with helping retain the section of the cable against the surface, the cable clasping device also prevents a misplacement of and/or a damage to the apparatus.

In one aspect, a cable clasping device is described. The cable clasping device includes a body and a mounting system. The body defines an outer surface, a first end face, a second end face, and one or more retention structures configured to receive a section of a cable to retentively secure the section of the cable with respect to the body. The retention structures define an indentation extending into a thickness of the body from the outer surface and spanning between the first end face and the second end face to facilitate the section of the cable to be accommodated and routed through the body. The mounting system is configured to mount the body against a surface to retain the section of the cable against the surface.

Reference will now be made in detail to specific embodiments or features, examples of which are illustrated in the accompanying drawings. Generally, corresponding reference numbers may be used throughout the drawings to refer to the same or corresponding parts, for example, 1, 1′, 1″, 101 and 201 could refer to one or more comparable components used in the same and/or different depicted embodiments.

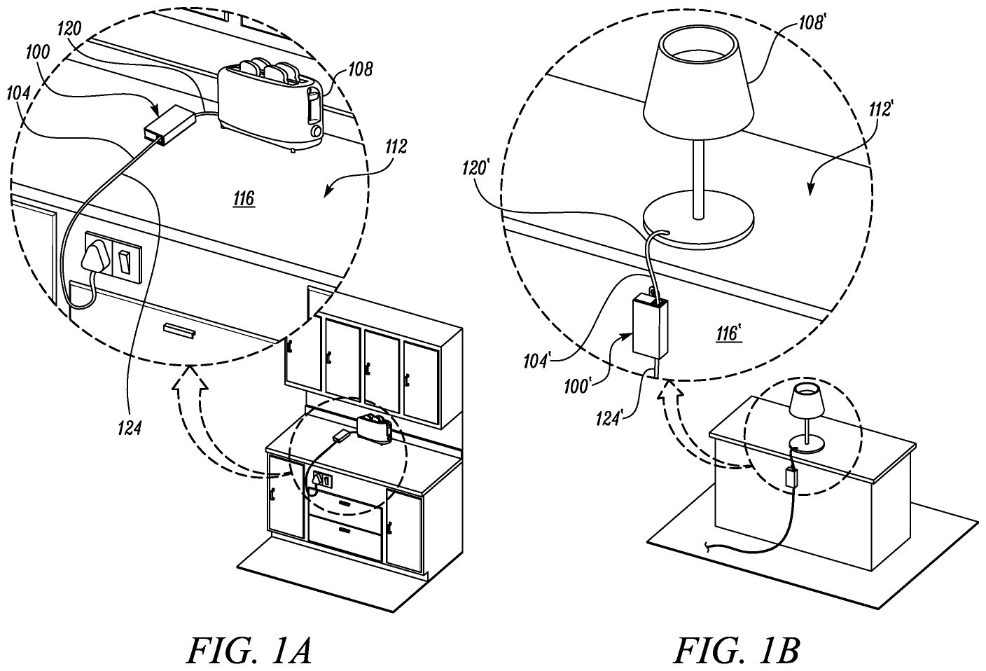

Referring to FIGS. 1A and 1B, exemplary cable clasping devices 100, 100′ in their respective exemplary applications are shown. The cable clasping devices 100, 100′ are applied to prevent misplacement of a cable with respect to a surface and/or to prevent a misplacement of or a damage to an apparatus from which the cable extends. The term ‘misplacement’ when used with respect to the cable and/or the apparatus shall be understood as preventing any excessive movement of the section of the cable and/or the apparatus, either of which can result in damage to the cable and/or the apparatus. Many applications of the cable clasping devices 100, 100′, such as those depicted in FIGS. 1A and 1B can be contemplated, and those described in FIGS. 1A and 1B are solely exemplary.

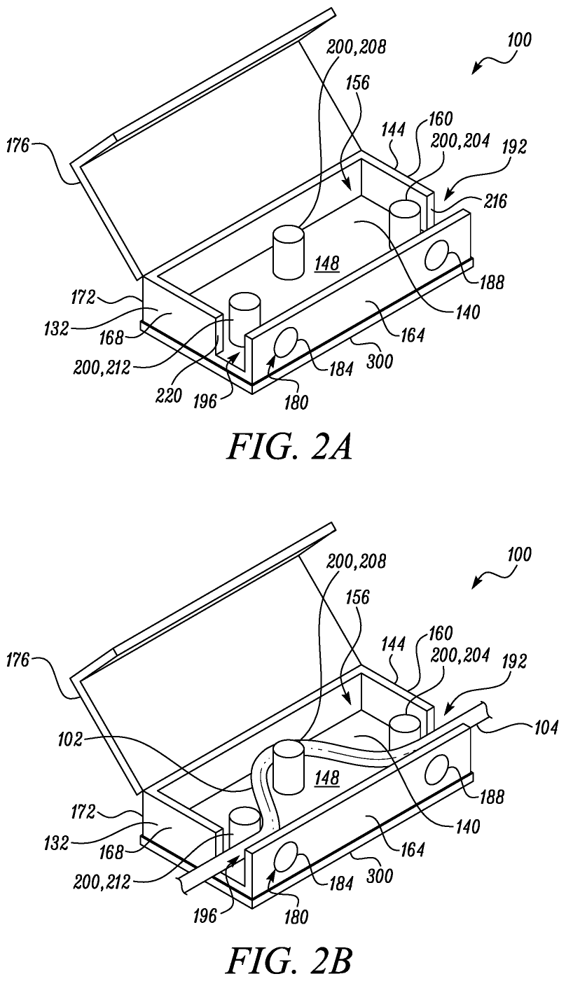

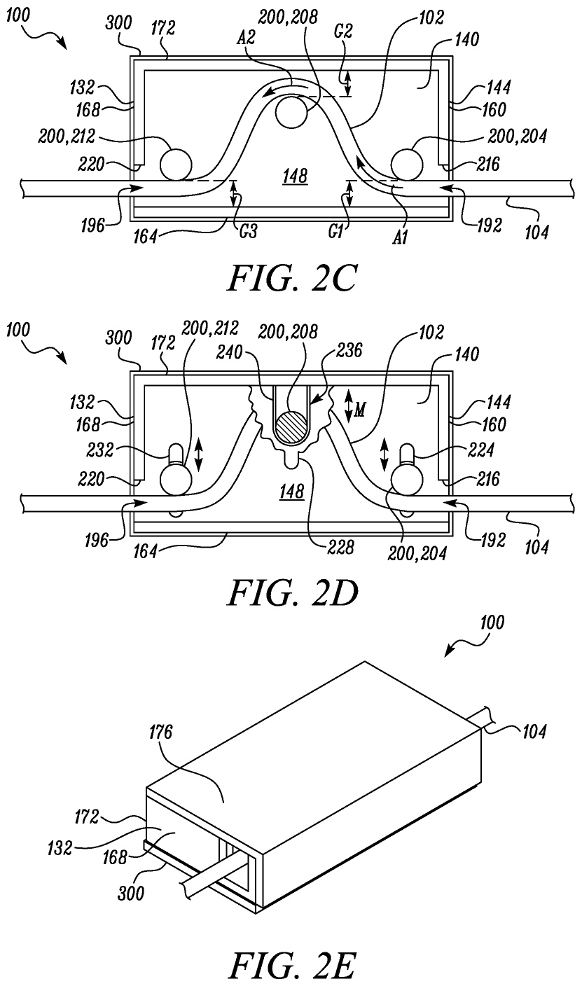

In FIG. 1A, for example, the cable clasping device 100 is applied to clasp a section 102 of a cable 104 (see section 102 in FIG. 2B) that extends from an apparatus 108. As an example, the apparatus 108 is an electrical appliance such as a toaster. As exemplarily shown in FIG. 1A, the apparatus 108 is placed over a counter top 112, which is customarily found in a commercial and/or a household kitchen, and the cable clasping device 100 is mounted and retained over a working surface 116 of the counter top 112 and receives the section 102 of the cable 104 disposed in close relative proximity to the apparatus 108 so as to clasp the section 102 of the cable 104. In that manner, the section 102 of the cable 104 is retained against the working surface 116 of the counter top 112.

In FIG. 1B, for example, the cable clasping device 100′ is applied to clasp a section (similar to section 102, see FIG. 2B) of a cable 104′ that extends from another apparatus 108′. As an example, the apparatus 108′ is an electrical appliance such as a table lamp. As exemplarily shown in FIG. 1B, the apparatus 108′ is placed over a dresser table 112′ and the cable clasping device 100′ is mounted and retained onto a side surface 116′ of the dresser table 112′ and receives the section of the cable 104′ disposed in close relative proximity to the apparatus 108′ so as to clasp said section of the cable 104′. In that manner, said section of the cable 104′ is retained against the side surface 116′ of the dresser table 112′.

In each of the aforementioned example applications, the cable clasping devices 100, 100′ receive and/or clasp a section (for example, section 102) of the corresponding cables 104, 104′ such that the corresponding cables 104, 104′ are divided into corresponding proximal cable portions 120, 120′ and corresponding distal cable portions 124, 124′. The proximal cable portions 120, 120′ are disposed relatively proximally to the corresponding apparatuses 108, 108′, while the distal cable portions 124, 124′ are disposed relatively distally to the corresponding apparatuses 108, 108′. Because the cable clasping devices 100, 100′ clasp the corresponding sections of the corresponding cables 104, 104′ and retain the same against the corresponding surfaces 116, 116′, the cable clasping devices 100, 100′ help prevent a misplacement of the corresponding sections of the corresponding cables 104, 104′ and/or prevent a damage to the corresponding apparatus 108, 108′ when the corresponding cables 104, 104′ are mishandled or inadvertently pulled at from their corresponding distal cable portions 124, 124′.

Although the cable clasping device 100 is illustrated to be exemplarily applied on the working surface 116 and the cable clasping device 100′ is illustrated to be exemplarily applied on the side surface 116′, it will be appreciated that said applications of cable clasping devices 100, 100′ can be reversed. In other words, the cable clasping device 100 can be applied on the side surface 116′, while the cable clasping device 100′ can be applied on the working surface 116. In particular, it will be appreciated that the cable clasping device 100 is not restricted to be used on a horizontal surface, such as the working surface 116, but it can also be suitably used on any other surface, such as a vertical surface, an inclined surface, a curved surface, or an irregular surface. Likewise, it will be appreciated that the cable clasping device 100′ is also not restricted to be used on a vertical surface, such as the side surface 116′, but it can also be suitably used on any other surface, such as a horizontal surface, an inclined surface, a curved surface, or an irregular surface. Features of the cable clasping devices 100, 100′ shall be described in the forthcoming description. As the description proceeds, it will become apparent that there are also differences between the cable clasping devices 100, 100′. Said differences can be optional differences. All the features of the cable clasping devices 100, 100′ fall within the ambit of the claimed subject matter.

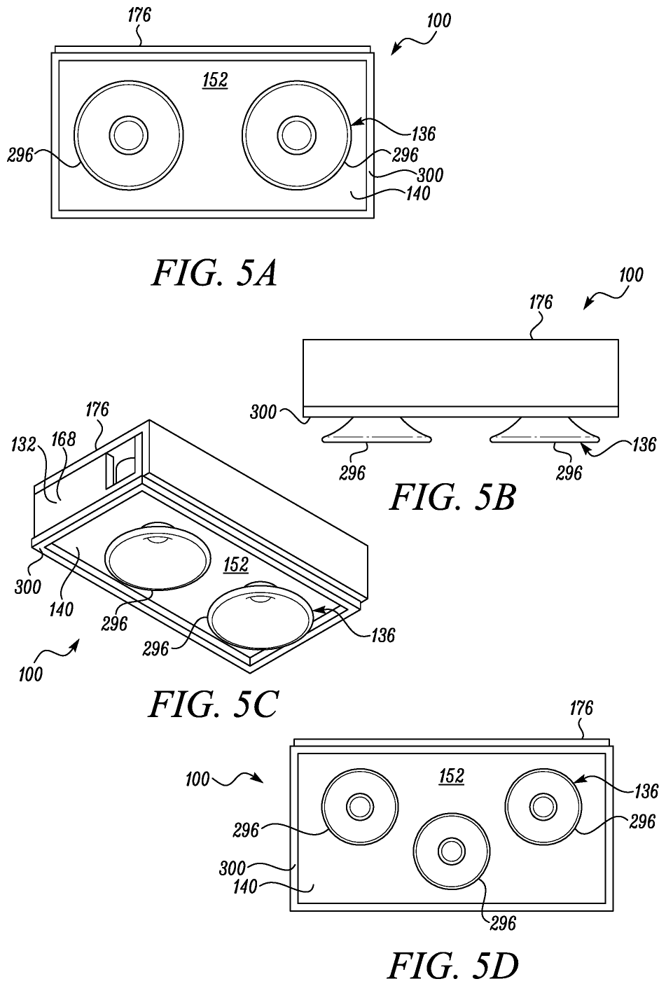

Referring to FIGS. 2A through 2E, and also in conjunction with FIGS. 5A through 5D, the cable clasping device 100 is described. The description corresponding to the cable clasping device 100 is equitably applicable to the cable clasping device 100′, as well. The cable clasping device 100 includes a body 132 and a mounting system 136. The mounting system 136 is best shown in FIGS. 5A through 5D. The body 132 defines a base portion 140 and a wall portion 144. As an example, the base portion 140 includes a rectangular profile and takes the form of a planarly extending flat structure that defines a first surface 148 and a second surface 152 (see FIGS. 5A and 5D). The base portion 140 can include other shapes or profiles, such as a hexagonal profile, or an octagonal profile, or any other shaped profile, or one that inherently adds aesthetic or decorative value to the cable clasping device 100 and which is more pleasing to look at and/or more ergonomic to hold. The second surface 152 is defined oppositely to the first surface 148.

The wall portion 144 at least partly surrounds the base portion 140 and extends upright with respect to the base portion 140 to define a recess 156 within the body 132. More particularly, the wall portion 144 defines a first wall portion 160, a second wall portion 164, a third wall portion 168, and a fourth wall portion 172, all combinedly surrounding the base portion 140 such that together the first wall portion 160, the second wall portion 164, the third wall portion 168, and the fourth wall portion 172, in conjunction with the first surface 148, define the recess 156. Given the aforesaid rectangular profile of the base portion 140, the body 132 and/or to the cable clasping device 100 defines a cuboidal structure, although the cable clasping device 100 can include various other profiles.

The cable clasping device 100 also includes a gate portion 176. The gate portion 176 is pivotably coupled to the body 132—for example, the gate portion 176 is hinged to the fourth wall portion 172 (by use of a suitable mechanism which is now known or in the future developed) to swing back and forth with respect to the fourth wall portion 172. In so doing, the gate portion 176 is movable between a closed state (see FIG. 2E) and an opened state (see FIGS. 2A and 2B) with respect to the recess 156—where, in the opened state, the gate portion 176 opens the recess 156, and, in the closed state, the gate portion 176 closes the recess 156. During an application of the cable clasping device 100, the gate portion 176 can be moved to the closed state to enclose the section 102 of the cable 104 within the recess 156 and/or moved to the opened state to gain access to the section 102 of the cable 104 accommodated or passing through the recess 156.

In some embodiments, the cable clasping device 100 includes a fastening mechanism 180 to retain the gate portion 176 in the closed state. In some embodiments, the fastening mechanism 180 includes magnetic fastening elements 184, 188. As exemplarily shown, the magnetic fastening elements 184, 188 are arranged on the second wall portion 164 of the body 132 against which the gate portion 176 is abutted to or is brought in contact with such that a fastening between the gate portion 176 and the second wall portion 164 is attained by magnetic force. Variations to such a mechanism can be contemplated by someone skilled in the art. Further, various other types of fastening mechanisms, such as a snap-fit mechanism or a threadable mechanism, or any other mechanism now known or in the future developed, can also be contemplated.

The body 132 also defines one or more openings in one or more of the base portion 140, the wall portion 144, and the gate portion 176. As an example, the body 132 defines two openings—a first opening 192 and a second opening 196. The first opening 192 and the second opening 196 are formed in the wall portion 144 of the body 132, and, more particularly, the first opening 192 and the second opening 196 are respectively formed in the first wall portion 160 and the third wall portion 168 of the body 132. In the illustrated example of FIGS. 2A through 2E, both the first opening 192 and the second opening 196 are formed relatively closer towards the second wall portion 164 than to the fourth wall portion 172. The openings 192, 196 can also be formed elsewhere along the extents of the first wall portion 160 and the third wall portion 168, respectively, based upon need or the type of application that the cable clasping device 100 is employed in.

The body 132 defines one or more retention structures 200 configured to receive the section 102 of the cable 104 to retentively secure and lock the section 102 of the cable 104 with respect to the body 132. The retention structures 200 are arranged on the first surface 148 and within the recess 156 to be accommodated within the recess 156. As an example, the retention structures 200 include one or more protrusions extending outwards from the base portion 140 (or from the first surface 148 of the base portion 140). In the illustrated embodiments of FIGS. 2A through 2E, the retention structures 200 exemplarily include three protrusions—for example, a first protrusion 204, a second protrusion 208, and a third protrusion 212, each extending from the base portion 140. Although three protrusions 204, 208, 212 are described, a higher or a lower number of protrusions can be provided. The protrusions 204, 208, 212 extend exemplarily uprightly and/or linearly with respect to the first surface 148, although, in some cases, one or more of the protrusions 204, 208, 212 can extend angularly with respect to the first surface 148.

The protrusions 204, 208, 212 include a cross-sectional area which is circular, and thus the protrusions 204, 208, 212 are cylindrically shaped. It is however possible for said protrusions 204, 208, 212 to include a different cross-sectional area, such as a polygonal cross-sectional area, an elliptical cross-sectional area, or an irregular cross-sectional area. A cross-sectional area of one protrusion can also differ from a cross-sectional area of another protrusion. Alternatively, the cross-sectional areas of all protrusions 204, 208, 212 can be the same, in certain cases. In some embodiments, it is possible for the cross-sectional area of one or more of the protrusions 204, 208, 212 to vary as they extend outwards and/or away from the first surface 148.

The protrusions 204, 208, 212 are arranged in a non-linear manner on the first surface 148 of the base portion 140 and span out between the first wall portion 160 and the third wall portion 168, as shown. As an example, the protrusions 204, 208, 212 are arrayed in at least one of a zig-zag manner and/or an irregular manner on the base portion 140 from a side of the first wall portion 160 towards the third wall portion 168. FIGS. 2A through 2E illustrate an exemplarily layout or arrangement of the protrusions 204, 208, 212 in a zig-zag manner. Such non-linear arrangement of the protrusions 204, 208, 212 help the retention structures 200 define a non-linear pathway into which the section 102 of the cable 104 is received during use or application of the cable clasping device 100. In some embodiments, the non-linear pathway includes or corresponds to a zig-zag pathway—see pathway through which the section 102 of the cable 104 is routed in FIGS. 2B and 2C. The zig-zag pathway allows or enables the section 102 of the cable 104 to acquire one or more bends when the section 102 of the cable 104 is received in the recess 156 and around the protrusions 204, 208, 212, in turn causing the section 102 of the cable 104 to be retentively secured and locked with respect to the body 132. In alternative embodiments, the openings 192, 196 can be respectively formed on the second wall portion 164 and the fourth wall portion 172. In such a case, the arrangement of the protrusions 204, 208, 212 can accordingly change to span out between the second wall portion 164 and the fourth wall portion 172.

As an exemplary layout of the protrusions 204, 208, 212 on the first surface 148 of the base portion 140, the first protrusion 204 and the third protrusion 212 are both positioned closer to the second wall portion 164 than to the fourth wall portion 172. Moreover, the first protrusion 204 is positioned closer to the first wall portion 160 than to the third wall portion 168, while the third protrusion 212 is positioned closer to the third wall portion 168 than to the first wall portion 160. In that manner, the first protrusion 204 acquires a position which is relatively close to the first opening 192 than to the second opening 196 and the third protrusion 212 acquires a position which is relatively close to the second opening 196 than to the first opening 192. The second protrusion 208 is positioned closer to the fourth wall portion 172 than to the second wall portion 164, and, although not limited, the second protrusion 208 acquires a position that is generally midway between the first protrusion 204 and the third protrusion 212 and/or that is at the same distance from the first protrusion 204 and the third protrusion 212. As illustrated in FIG. 2C, a gap, G1, is defined between the first protrusion 204 and the second wall portion 164, a gap, G2, is defined between the second protrusion 208 and the fourth wall portion 172, and a gap, G3, is defined between the third protrusion 212 and the second wall portion 164.

Referring to FIG. 2C, during an application of the cable clasping device 100, the section 102 of the cable 104 is at least partially and successively wound around at least two protrusions such that one part of the section 102 is at least partially wound around one protrusion (for example, the first protrusion 204) in a first angular direction, A1, and another part of the section 102 is at least partially wound around another protrusion (for example, the second protrusion 208) in a second angular direction, A2. The first angular direction, A1, is opposite to or is in reverse to the second angular direction, A2.

More particularly, the section 102 of the cable 104 is routed into the recess 156 of the cable clasping device 100 through the first opening 192, pushed (or pressed) into the gap, G1, turned or bent in a first angular direction, A1, to reach out and be pushed (or pressed) into the gap, G2, further turned or bent (for example, in a second angular direction, A2, which is reverse or opposite to the first angular direction, A1) to reach out and be pushed (or pressed) into the gap, G3, and then finally routed out from the cable clasping device 100 through the second opening 196. In that manner, the section 102 of the cable 104 is passed into the recess 156 through the openings 192, 196 to be received into the retention structures 200. Also, the section 102 of the cable 104 is routed through the recess 156 by being at least partially wound around each of the protrusions 204, 208, 212. When the section 102 of the cable 104 is passed and/or accommodated into the recess 156, the section 102 of the cable 104 acquires at least one U-shaped or a V-shaped bend. In some embodiments, when the cable 104 includes a relatively small cross-sectional area, or, in other words, when the cable 104 is relatively thin, the cable 104 could be wound around one or more of the protrusions 204, 208, 212 completely or a number of times (that is to say 360 degrees or more) such that the retention of the section 102 of the cable 104 within the recess 156 can be more effectively attained.

In some embodiments, the first protrusion 204 and the third protrusion 212 can be omitted, and the corresponding turn or bend (for example, the first angular direction, A1) in the section 102 of the cable 104 can be induced and/or attained by making the section 102 of the cable 104 abut and turn against the corresponding edges 216, 220 (see FIG. 2C) of the first wall portion 160 and the third wall portion 168 that respectively (and partly) defines the first opening 192 and the second opening 196. Further, it will be noted that the gap, G1, between the first protrusion 204 and the second wall portion 164 and the gap, G3, between the third protrusion 212 and the second wall portion 164 are large enough to accommodate a passage of the section 102 of the cable 104 therethrough. Similarly, the gap, G2, between the second protrusion 208 and the fourth wall portion 172 is large enough to accommodate a passage of the section 102 of the cable 104 therethrough.

Referring to FIG. 2D, and, in some embodiments, one or more of the gaps, G1, G2, G3, are adjustable to receive varying sized cables. To enable gap adjustments, one or more of the protrusions 204, 208, 212 are configured to move (see example direction, M) on the base portion 140 to at least partially receive differently sized cables therearound. To this end, the base portion 140 can include tracks, with exemplarily, one track corresponding to or being available for one protrusion. As an example, the first protrusion 204 is guided on a first track 224, the second protrusion 208 is guided on a second track 228, and the third protrusion 212 is guided on a third track 232. The tracks 224, 228, 232 extend linearly between the second wall portion 164 and the fourth wall portion 172 and are parallel to each other. In some embodiments, the protrusions 204, 208, 212 can be retained at a desired location or position on the corresponding tracks 224, 228, 232 through a use of a fastener—the manner in which such a fastener could be applied can be contemplated by someone in the art based on the description herein and is thus not discussed.

Additionally, or optionally, the cable clasping device 100 can include a self-adjusting mechanism corresponding to each protrusion. With regard to the second protrusion 208, for example, a self-adjusting mechanism 236 is shown in FIG. 2D. The self-adjusting mechanism 236 includes an elastic band 240 that can be wound around a portion of the second protrusion 208 and which can be affixed to the fourth wall portion 172 such that as the second protrusion 208 is moved away from the fourth wall portion 172 along the length of the second track 228 or along the direction, M, the elastic band 240 is able to apply tension against said movement to pull and bias the second protrusion 208 towards the fourth wall portion 172. Similar self-adjusting mechanisms can be provided for the first protrusion 204 and the third protrusion 212, as well. Variations to such a mechanism can also be contemplated by someone skilled in art.

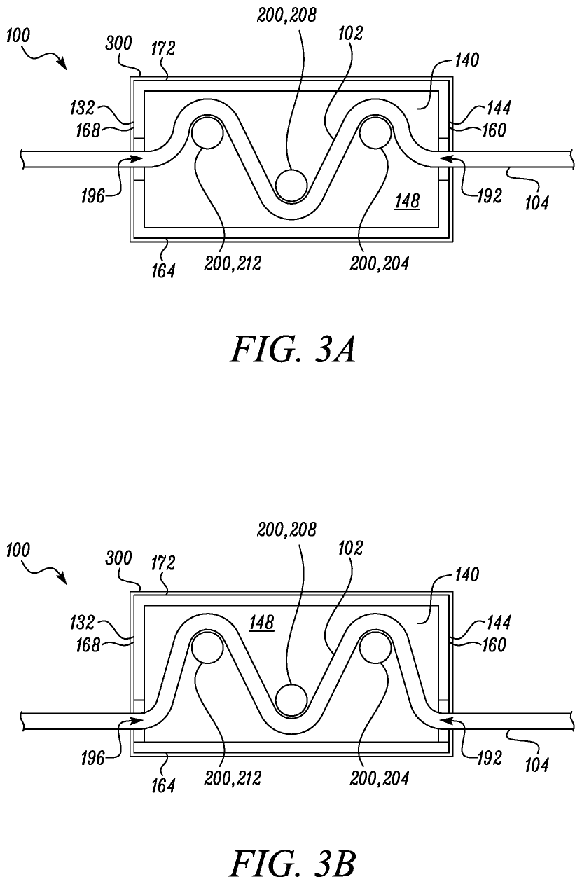

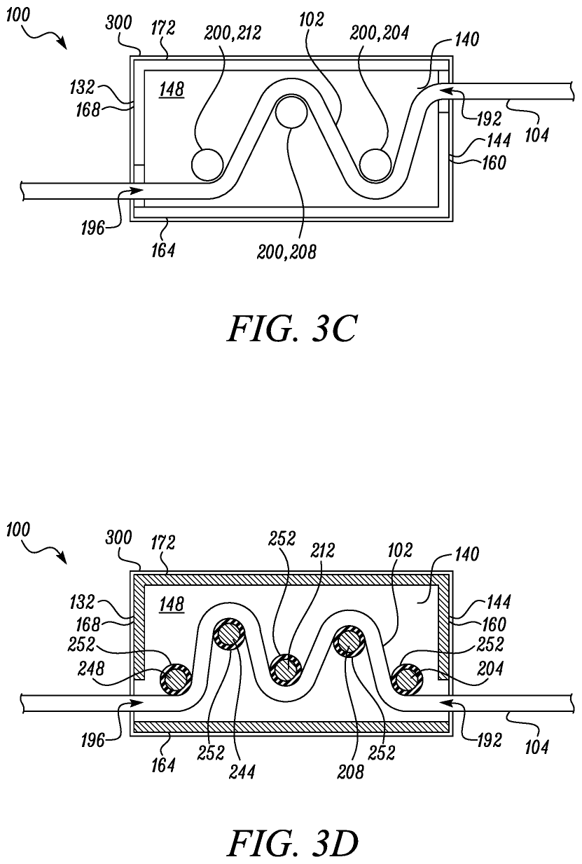

Referring to FIGS. 3A through 3D, exemplary variations in the structural and configurational details of the cable clasping device 100 is described. As shown, the variations mainly correspond to changes in the positions of one or more of the retention structures 200 or the protrusions 204, 208, 212 and/or the positions of the openings 192, 196. For example, in FIG. 3A, the first opening 192 and the second opening 196 are centrally positioned with respect to the first wall portion 160 and the third wall portion 168, respectively; the first protrusion 204 and the third protrusion 212 are closer to the fourth wall portion 172 than to the second wall portion 164; and the second protrusion 208 is closer to the second wall portion 164 than to the fourth wall portion 172. For example, in FIG. 3B, the first opening 192 and the second opening 196 are each closer to the second wall portion 164 than to the fourth wall portion 172; the first protrusion 204 and the third protrusion 212 are closer to the fourth wall portion 172 than to the second wall portion 164; and the second protrusion 208 is closer to the second wall portion 164 than to the fourth wall portion 172. For example, in FIG. 3C, the first opening 192 is closer to the fourth wall portion 172 than to the second wall portion 164 while the second opening 196 is closer to the second wall portion 164 than to the fourth wall portion 172; the first protrusion 204 and the third protrusion 212 are closer to the second wall portion 164 than to the fourth wall portion 172; and the second protrusion 208 is closer to the fourth wall portion 172 than to the second wall portion 164.

With reference to FIG. 3D, and in some embodiments, the retention structures 200 includes protrusions in addition to the first protrusion 204, the second protrusion 208, and the third protrusion 212—for example, the additional protrusions include a fourth protrusion 244 and a fifth protrusion 248. Said protrusions 244, 248 are arranged in the recess 156 and on the base portion 140 in a manner similar to the way the first protrusion 204, the second protrusion 208, and the third protrusion 212, are arranged in the recess 156 and on the base portion 140. Combinedly, the first protrusion 204, the second protrusion 208, the third protrusion 212, the fourth protrusion 244, and the fifth protrusion 248, define a serpentine pathway for the section of the cable to pass therethrough—see pathway through which the section 102 of the cable 104 is routed in FIG. 3D.

As an example, the first protrusion 204, the third protrusion 212, and the fifth protrusion 248, are all positioned closer to the second wall portion 164 than to the fourth wall portion 172, while the second protrusion 208 and the fourth protrusion 244 are positioned closer to the fourth wall portion 172 than to the second wall portion 164. Moreover, the first opening 192 and the second opening 196 are positioned closer to the second wall portion 164 than to the fourth wall portion 172. Various alternatives to the layout of the protrusions 204, 208, 212, 244, 248 and the openings 192, 196 are possible, and those that are described here are purely exemplary.

In some embodiments, one or more of the protrusions 204, 208, 212, 244, 248 includes a friction surface 252 to engage the section 102 of the cable 104 by frictional force and impede a motion (or displacement) of the section 102 of the cable 104 with respect to one or more of the protrusions 204, 208, 212, 244, 248. For example, and with reference to the cross-sectional views of the protrusions 204, 208, 212, 244, 248 in FIG. 3D, it is seen that each of the protrusions 204, 208, 212, 244, 248 (that form the many retention structures 200 of the cable clasping device 100) include the friction surface 252 (that includes a frictional outer layer, for example) interfacing and engaging with the section 102 of the cable 104 by frictional force when the cable 104 is laid into the recess 156 to pass through the pathway defined by the protrusions 204, 208, 212, 244, 248. In so doing, during application of the cable clasping device 100, the friction surface 252 disposed around each of the protrusions 204, 208, 212, 244, 248 contacts the section 102 of the cable 104 to impede a motion (or displacement) of the section 102 of the cable 104 with respect to itself and the cable clasping device 100. In some embodiments, the friction surface 252 (or the frictional outer layer) are provided only on some of the protrusions 204, 208, 212, 244, 248 and not on all of the protrusions 204, 208, 212, 244, 248. A size of the friction surface 252 or the frictional outer layer illustrated for corresponding to protrusions 204, 208, 212, 244, 248 is exaggerated for illustrative purposes.

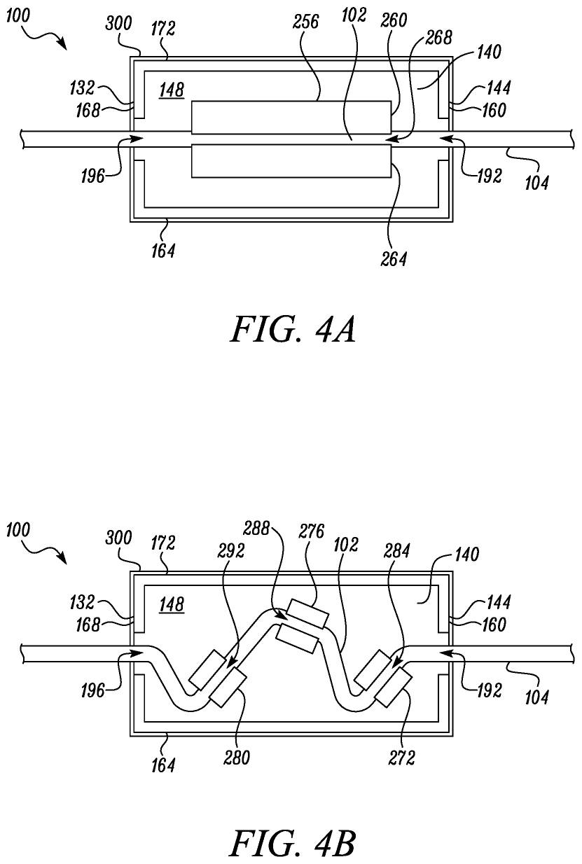

Referring to FIGS. 4A and 4B, certain exemplary variations to the retention structures 200 of the cable clasping device 100 is described. For example, the retention structures 200 include one or more teeth assemblies instead of any of the protrusions 204, 208, 212, 244, 248. Teeth assemblies can correspond to one or more assemblies each of which includes at least two mutually spaced apart jaws or teeth members that can move away from each other when the section 102 of the cable 104 is pushed into a space or a receptacle defined between them. In so doing, the jaws or teeth assemblies move away from a default state to an expanded state in which they receive the section 102 of the cable 104 into the space or the receptacle. Once the section 102 of the cable 104 is received into the space or the receptacle, the jaws or teeth members can return to their default state from the expanded state.

With reference to FIG. 4A, for example, the cable clasping device 100 includes one teeth assembly 256. Said teeth assembly 256 includes a set of flexible teeth members 260, 264 and a receptacle 268 accessible through the set of flexible teeth members 260, 264. In such a case, the section 102 of the cable 104 is configured to be pushed and snap-fitted into the receptacle 268 through the set of flexible teeth members 260, 264 to retentively secure and lock the section 102 of the cable 104 with the body 132.

As shown, the receptacle 268 exemplarily provides a linear pathway to the section 102 of the cable 104 to linearly route the cable 104 therethrough (see pathway through which the section 102 of the cable 104 is routed in FIG. 4A). This is unlike the non-linear pathway defined by the protrusions 204, 208, 212, 244, 248 in FIGS. 2A through 3D. Nevertheless, it is possible for the receptacle 268 to define a non-linear pathway to non-linearly route the section 102 of the cable 104 therethrough and/or for the teeth assembly 256 or the receptacle 268 to be oriented differently (than the orientation depicted in FIG. 4A) such that said orientation of the teeth assembly 256 or the receptacle 268 causes the section 102 to acquire one or more bends to non-linearly route the section 102 of the cable 104 therethrough.

With reference to FIG. 4B, the cable clasping device 100 includes multiple teeth assemblies. For example, the multiple teeth assemblies correspond to a first teeth assembly 272, a second teeth assembly 276, and a third teeth assembly 280. Each of the first teeth assembly 272, the second teeth assembly 276, and the third teeth assembly 280, are similar to the teeth assembly 256 of FIG. 4A and defines corresponding receptacles 284, 288, 292 which are similar to the receptacle 268. However, the first teeth assembly 272, the second teeth assembly 276, and the third teeth assembly 280 are oriented differently with respect to each other such that when the section 102 of the cable 104 is received into the corresponding receptacles 284, 288, 292 of the first teeth assembly 272, the second teeth assembly 276, and the third teeth assembly 280, at least one bend is induced in the section 102 of the cable 104. More particularly, by way of differently orienting the teeth assemblies 272, 276, 280 a non-linear pathway for the section 102 of the cable 104 is defined when the section 102 of the cable 104 is received into the receptacles 284, 288, 292 of the teeth assemblies 272, 276, 280. In some embodiments, the teeth assembly 256 and/or the teeth assemblies 272, 276, 280 can be provided along with one or more of the protrusions 204, 208, 212, 244, 248 which are described in conjunction with FIGS. 2A through 3D.

Various parts and features associated with the body 132 of the cable clasping device 100, such as the retention structures 200, wall portion 144, gate portion 176, and the base portion 140, described above, can be made from one or more of a metal, a plastic, and/or a polymer. In some embodiments, the body 132 and the retention structures 200 can be formed integrally by casting a suitable material or an alloy in a single mold. Alternatively, the retention structures 200 (for example, the protrusions 204, 208, 212 and/or the teeth assemblies 256, 272, 276, 280) are separable from the rest of the body 132 such that the retention structures 200 can be assembled and/or disassembled with respect to the base portion 140, as and when needed. For example, a coupling between the retention structures 200 and the base portion 140 can be attained threadably or through a snap-fit connection or any other connection means now known or in the future developed.

Referring to FIGS. 5A through 5D, details associated with various embodiments of the mounting system 136 are described. The mounting system 136 is configured to mount the body 132 against the surface 116 to retain the section 102 of the cable 104 against the surface 116. As shown, the mounting system 136 includes one or more suction members 296. The suction members 296 are coupled to the body 132 (for example, fixedly coupled to the second surface 152 of the base portion 140 of the body 132) and includes suctions heads that are engageable with the surface 116 by an application of a suction force to retain the body 132 removably against the surface 116. As an example, the suction members 296 are in the form of or correspond to suction cups that when pressed against the surface 116 can be retained to the surface 116. Further, the suction members can be provided in any number—for example, two suction members 296 can be provided (see FIG. 5A, 5B, 5C) or three suction members 296 can be provided (see FIG. 5D), or a lesser or a higher number of suction members 296 can be provided on the second surface 152 of the base portion 140.

With continued reference to FIGS. 5A through 5D, the body 132 also defines a lip 300 extending outwardly from the second surface 152 of the base portion 140 of the body 132. In some embodiments, the lip 300 extends orthogonally and outwardly from the second surface 152 of the base portion 140 of the body 132, although the lip 300 can extend angularly with respect to the second surface 152. As shown, the lip 300 is defined peripherally around the second surface 152. During applications, when the cable clasping device 100 is pushed against the surface 116 to allow the suction members 296 to engage with the surface 116 and retain the body 132 against the surface 116, the lip 300 is moved towards the surface 116 to at least partially screen or cover the mounting system 136 from the outside. In some embodiments, the lip 300 sits flush with the surface 116 when the cable clasping device 100 is pushed against the surface 116 and the suction members 296 are in engagement with the surface 116.

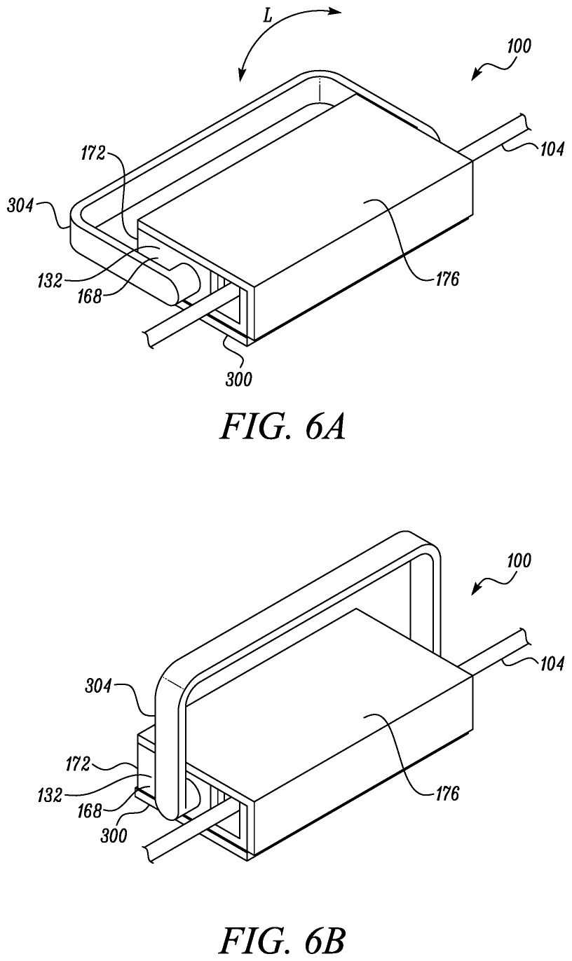

Referring to FIGS. 6A and 6B, and in some embodiments, the mounting system 136 of the cable clasping device 100 includes a lever 304. The lever 304 is movable (see direction, L) to a first position (see FIG. 6A) and to a second position (see FIG. 6B). In the first position, the lever 304 applies the suction force to enable the suction members 296 and thus the body 132 to engage and be retained with the surface 116, and, in the second position, the lever 304 releases the suction force to release the suction members 296 and the body 132 from the surface 116. In some embodiments, the function of the lever 304 can be performed by the gate portion 176, and, in such a case, when the gate portion 176 is moved to the closed state (see FIG. 2E), the suction force is applied, and when the gate portion 176 is moved to the opened state (see FIGS. 2A and 2B), the suction force is released.

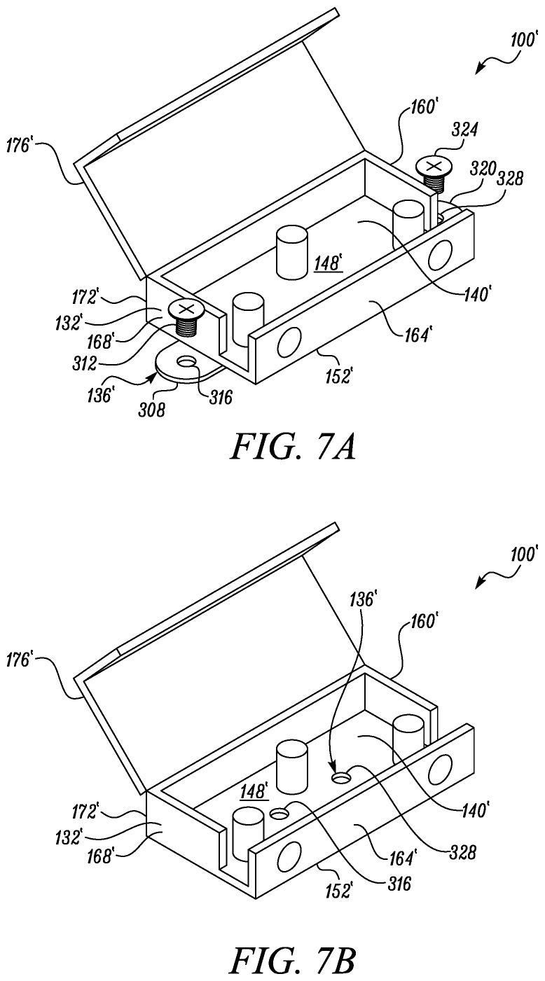

Referring to FIGS. 7A and 7B, the cable clasping device 100′ is described. The description associated with the cable clasping device 100 is applicable to the cable clasping device 100′ as well, with the exception that the cable clasping device 100′ includes a mounting system 136′ that differs from the mounting system 136 of the cable clasping device 100. In some embodiments, it is possible for the cable clasping devices 100′ to include the mounting systems 136, along with the mounting system 136′, as well. Therefore, the entire set of FIGS. from 2A to 6B can be equitably applicable to cable clasping device 100′, as well. Moreover, the mounting systems 136, 136′ are exemplary embodiments and variations to said mounting systems 136, 136′ can be contemplated by someone skilled in the art.

Same or similar reference numerals are used for the same or like parts. For example, the cable clasping device 100′ includes a body 132′ which is similar to the body 132 of the cable clasping device 100. Similar to the description of the body 132, the body 132′ defines a base portion 140′ having a first surface 148′ and a second surface 152′. Moreover, the body 132′ defines a first wall portion 160′, a second wall portion 164′, a third wall portion 168′, and a fourth wall portion 172′, that are correspondingly similar to the first wall portion 160, the second wall portion 164, the third wall portion 168, and the fourth wall portion 172 associated with the body 132 of the cable clasping device 100.

With regard to the mounting system 136′ of the cable clasping device 100′, the mounting system 136′ includes a plate 308 and one or more fasteners (for example, see fastener 312). The plate 308 is coupled to the body 132 and the fastener 312 is drivable through each of the plate 308 (for example, through a hole 316 in the plate 308) and the surface 116′ to mount and retain the body 132 fixedly against the surface 116′ (see FIG. 1B). As an example, the plate 308 extends outwards of the third wall portion 168′ of the body 132′, in and along a plane defined by the second surface 152′ of the base portion 140′, as shown.

A plate 320 (similar to the plate 308) is available, and the same extends outwards of the first wall portion 160′, in and along the plane defined by the second surface 152′ of the base portion 140′. A fastener 324, which is similar to the fastener 312, is drivable through the plate 320 (for example, through a hole 328 in the plate 320) and the surface 116′ so as to mount and retain the body 132′ fixedly against the surface 116′.

Optionally, and with reference to FIG. 7B, the holes 316, 328 are provided within the base portion 140′ and the same extends from the first surface 148′ of the base portion 140′ to the second surface 152′ of the base portion 140′ to allow the fasteners 312, 324 to be driven through the base portion 140′ to mount and retain the body 132′ fixedly against the surface 116′. In such a case, the plates 308, 320 can be omitted.

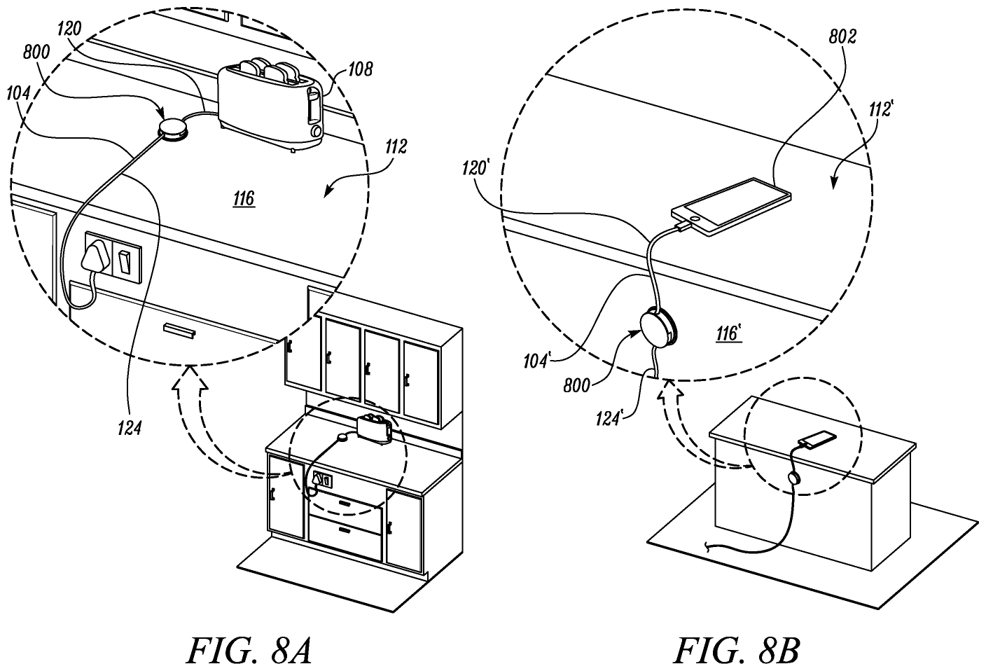

Referring to FIGS. 8A and 8B, an embodiment of the cable clasping devices 100, 100′ is shown and described. More particularly, a cable clasping device 800 is shown and the same is described in conjunction with its exemplary applications illustrated in FIGS. 8A and 8B. As will be understood by viewing FIGS. 8A and 8B, the cable clasping device 800 can have similar applications in similar environments as have been described above for the cable clasping device 100, 100′. Thus, the cable clasping device 800 can be used to retain the section 102 of the cable 104, or a section of any other such cable, such as a charging cable for a phone, tablet, and the like devices over any surface, such as the working surface 116, described above. In this regard, see exemplary device 802 using a charging cable. For ease in reference, the charging cable is annotated as “cable 102” in FIG. 8B, as shown.

Effectively, the references “section 102” and “cable 104” can be used to describe the application of the cable clasping device 800, as well. However, said references can relate to any cable and any corresponding section of any such cables. Also, same or similar reference numerals are used, wherever possible, for the applications illustrated in FIGS. 8A and 8B, as said applications can be similar to those provided in FIGS. 1A and 1B. It will be appreciated that the cable clasping device 800 includes one or more structural variations vis-à-vis the cable clasping device 100, 100′, and the same will be understood from the description further below.

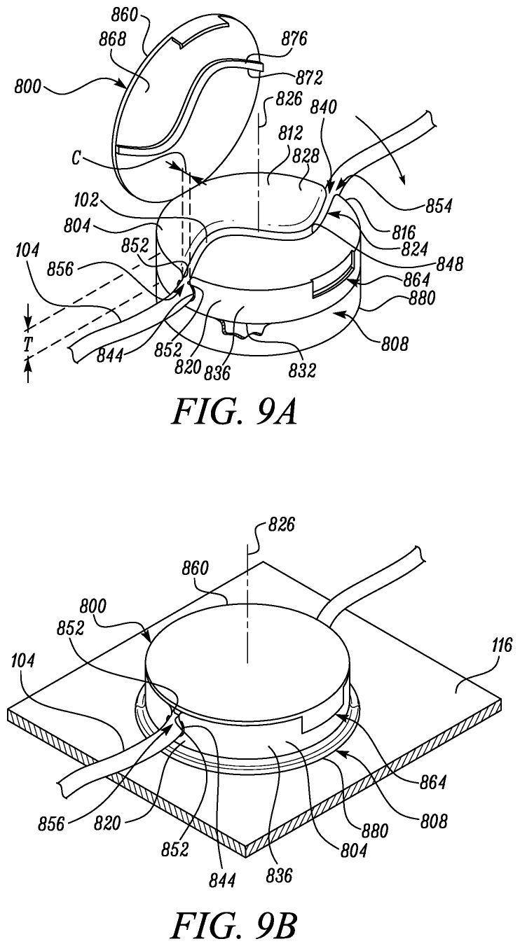

Referring to FIGS. 8A through 9B, the cable clasping device 800 includes a generally cylindrical structure, as against the exemplarily defined cuboidal structure for the cable clasping device 100, 100′, described above. In some embodiments, the cable clasping device 800 can also include an elliptical structure or an oblong structure or other structures (not shown), and which is contemplatable by someone skilled in the art based on the present description. Therefore, the cylindrical structure of the cable clasping device 800 is purely exemplary, and thus, is not limiting. As with the cable clasping devices 100, 100′, the cable clasping device 800 also includes a body 804 and a mounting system 808.

In further detail, the body 804 of the cable clasping device 800 includes an outer surface 812, a first end face 816, a second end face 820, and one or more retention structures (see retention structure 824). Given the cylindrical structure of the cable clasping device 800, the body 804 includes a circular or cylindrical shape as well, and accordingly defines an axis 826, a first axial end surface 828 (which is one and the same as the outer surface 812), and a second axial end surface 832. The second axial end surface 832 is disposed axially oppositely to the first axial end surface 828, as shown. Further, the body 804 also defines a thickness, T, and a side peripheral surface 836. Both the thickness, T, and the side peripheral surface 836 extends along the axis 826, and spans between the first axial end surface 828 and the second axial end surface 832.

As the body 804 can include a circular shape or profile, as described above, the first end face 816 and the second end face 820 can be located along a diameter (not shown) defined by the circular shape or profile. In other words, the first end face 816 and the second end face 820 can be disposed oppositely (for example, diametrically oppositely) about the body 804 and/or about the side peripheral surface 836 of the body 804. In case the cable clasping device 800 includes an elliptical structure, the corresponding body of the cable clasping device 800 can define a complementary elliptical shape as well in order to comport to the elliptical structure of the cable clasping device 800. Remainder features and details of such an elliptical structure can be contemplated based on the description corresponding to the cylindrical structure of the cable clasping device 800 added infra. It can be noted that when the body 804 includes the elliptical shape, the first end face 816 and the second end face 820 can be located along a major axis (not shown) defined by the corresponding elliptical shape of such a corresponding body.

Although not limited, the body 804 can be made in the same manner as has been described for the body 132, 132′ of the cable clasping devices 100, 100′. Moreover, the body 804 can be formed from any material now known, for example, a plastic material, any resilient or a flexible material, a polymeric material, or any other suitable material in the future developed.

The retention structure 824 is configured to receive the section 102 of the cable 104 to retentively secure the section 102 of the cable 104 with respect to the body 804. According to an aspect of the present description, the retention structure 824 defines an indentation 840. The indentation 840 extends into the thickness, T, of the body 804 from the outer surface 812 or from the first axial end surface 828 towards the second axial end surface 832. The indentation 840 stops short of the second axial end surface 832, or, in other words, the indentation 840 does not extend all the way till the second axial end surface 832. In some embodiments, the indentation 840 defines a circular cross-section along its expanse defined between the first end face 816 and the second end face 820.

In some embodiments, the indentation 840 defines an inner surface 844 which defines an interference fit with the section 102 of the cable 104, although it is possible for the inner surface 844 to define a gap to attain a clearance fit with the section 102 of the cable 104 passing therethrough, as and when the section 102 of the cable 104 is routed through the indentation 840. It will be appreciated that the interference fit, as the inner surface 844 interfaces with the section 102 of the cable 104 passing therethrough, can restrict or lock a movement or displacement of the section 102 of the cable 104 with respect to the body 804 or with respect to the inner surface 844 defined by the indentation 840 of the body 804. To this end, the inner surface 844 can define a friction coefficient higher than a friction coefficient defined on one or more other surfaces of the body 804.

In some embodiments, the indentation 840 also defines a mouth 848 where the indentation 840 (or the inner surface 844 of the indentation 840) meets the outer surface 812, and through which the section 102 of the cable 104 is received within the indentation 840. More particularly, and with regard to the mouth 848, the body 804 defines a pair of flexible lips 852 facing each other to shield and prevent the section 102 of the cable 104 from a disengagement from the indentation 840. As an example, the flexible lips 852 are integrally and contiguously extended from the inner surface 844 and are merged (for example, seamlessly and smoothly) with the outer surface 812 or the first axial end surface 828 of the body 804.

Also, as further example, a clearance, C, is defined between the flexible lips 852 to define the mouth 848 of the indentation 840. During a use of the cable clasping device 800, the section 102 of the cable 104 can be inserted through the clearance, C, (or through the mouth 848) defined between the pair of flexible lips 852 such that the section 102 of the cable 104 can enter and be accommodated into the indentation 840. In some embodiments, a coefficient of friction defined by each of the pair of flexible lips 852 is lower that the coefficient of friction defined by the inner surface 844. In some embodiments, the clearance, C, is smaller than a diameter or a width defined by the indentation 840.

The side peripheral surface 836 defines the first end face 816 and the second end face 820, and the indentation 840 spans between the first end face 816 and the second end face 820 to be open to the side peripheral surface 836 at each of the first end face 816 and the second end face 820. In that manner, the indentation 840 facilitates the section 102 of the cable 104 to be accommodated and routed through the body 804 of the cable clasping device 800. In other words, the section 102 of the cable 104 is introduced into the indentation 840 (or the body 804) through one of the first end face 816 and the second end face 820 and is routed out for exit from the indentation 840 (or the body 804) through the other of the first end face 816 and the second end face 820. To this end, the indentation 840 defines a first opening 854 at the first end face 816 to receive and/or route in the section 102 of the cable 104 into the indentation 840 and a second opening 856 at the second end face 820 to release and/or route the section 102 of the cable 104 out of the indentation 840.

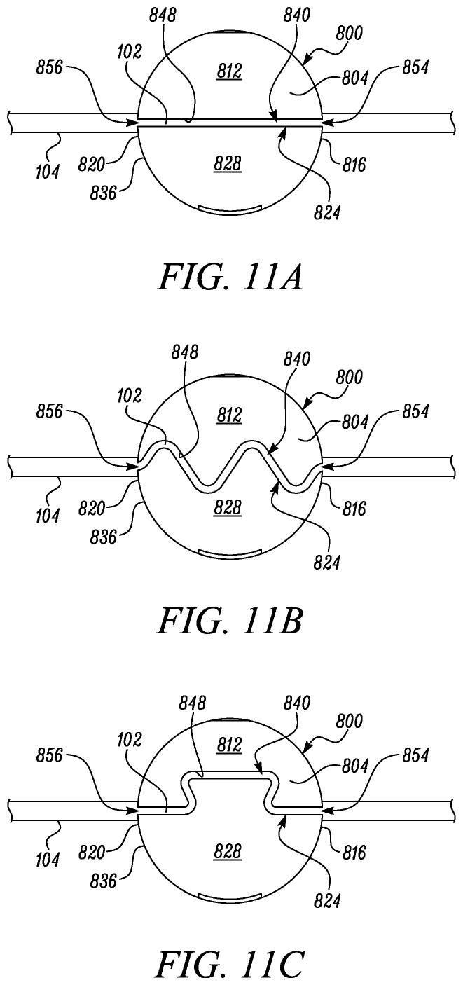

Referring to FIGS. 11A through 11C, and in some embodiments, the indentation 840 spans between the first end face 816 (or the first opening 854) and the second end face 820 (or the second opening 856) along a linear pathway (see exemplary indentation pathway illustrated in FIG. 11A). Although not limited, the linear pathway of the indentation 840 can be possible in case the first end face 816 (or the first opening 854) and the second end face 820 (or the second opening 856) are disposed oppositely (for example, diametrically oppositely) to each other. In some alternate embodiments, and/or conversely, the indentation 840 spans between the first end face 816 (or the first opening 854) and the second end face 820 (or the second opening 856) along a non-linear pathway (see exemplary indentation pathway illustrated in FIGS. 11B and 11C). As illustrated, the non-linear pathway can include one or more of a zig-zag pathway, a serpentine shaped pathway, an S-shaped pathway, and/or an irregular pathway.

Referring again to FIGS. 9A and 9B, as with the cable clasping device 100, 100′, the cable clasping device 800 includes a gate portion 860 to enclose the body 804 and thus the indentation 840. The gate portion 860 includes one or more of the same features and functions similarly as with the gate portion 176 of the cable clasping device 100, 100′, and thus, many of those features have not been discussed here again for brevity. As an example, the gate portion 860 includes a fastening mechanism 864 similar to the fastening mechanism 180 of the cable clasping device 100, 100′ that enables the gate portion 860 to be retained in a closed state (see FIG. 9B) with respect to the body 804. Further, the gate portion 860 also includes or defines an underside 868 (see FIG. 9A) which is directed towards the body 804 when the gate portion 860 is in the closed state with respect to the body 804.

According to one aspect of the present description, the cable clasping device 800 further includes a securing structure 872 (see FIG. 9A). The securing structure 872 is coupled to the gate portion 860. In some embodiments, the securing structure 872 is coupled to the gate portion 860 at the underside 868 of the gate portion 860 and defines a surface 876 projected outwardly and away from the underside 868, as shown. The surface 876 can enter into the indentation 840 when the gate portion 860 is moved to the closed state (see FIG. 9B). In this regard, as the surface 876 enters into the indentation 840 in the closed state of the cable clasping device 800, the securing structure 872 of the gate portion 860 contacts and compress against the section 102 of the cable 104 passing through the indentation 840. In so doing, the surface 876 applies a corresponding force against the section 102 of the cable 104 to secure the cable 104 within the indentation 840 (and thus within the cable clasping device 800) when the gate portion 860 is moved to the closed state, enclosing the section 102 of the cable 104 therewithin.

The securing structure 872 exemplarily includes a profile complementary to a profile of the mouth 848 of the indentation 840 such that the surface 876 can be received (at least in part) into the indentation 840. For example, as the indentation 840 spans between the first end face 816 (or the first opening 854) and the second end face 820 (or the second opening 856) along the linear or the non-linear pathway, the mouth 848 of the indentation 840 defines a corresponding linear or non-linear profile following the linear or non-linear pathway. The securing structure 872 (with the surface 876 included) defines a similar or complementary linear or non-linear profile so as to effectively match with and be at least partly received into the indentation 840 through the mouth 848 of the indentation 840. Although not limited, the securing structure 872 can be made from the same material as the body 804.

The mounting system 808 functions on the same principle (for example, the suction principle) as the mounting system 136 so as to be affixed and retained against a surface (for example, the working surface 116) (also see FIG. 9B), such as a table top, and the like, with the exception that the mounting system 808 includes a single suction member (for example, see suction member 880) as against multiple suction members. A profile of the suction member 880 encompasses and is spread out across the entire expanse of the second axial end surface 832 of the body 804, as illustrated. Such a configuration of the suction member 880 is applicable to utilize a maximum surface area available at the second axial end surface 832 of the body 804 by way of which a suction based mounting system (for example, the mounting system 808) can be applied against the working surface 116 with increased or enhanced suction power, in turn allowing the cable clasping device 800 to be retained against the surface 876 more effectively.

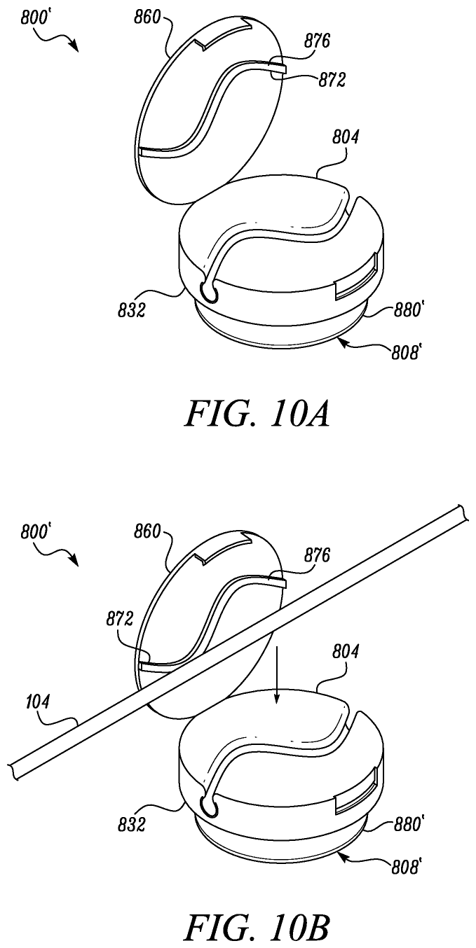

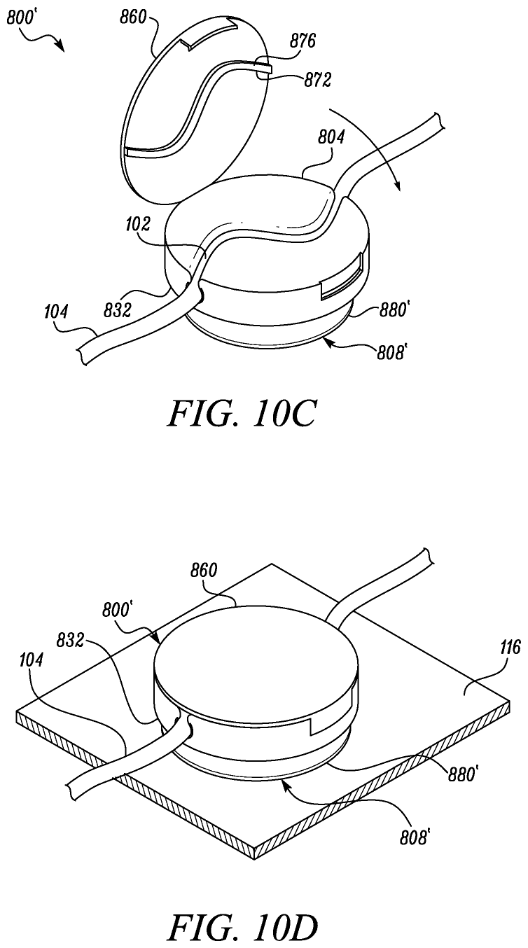

The above described configuration of the mounting system 808 is exemplary, and thus, the mounting system 808 can include variations vis-à-vis the aforesaid described configuration. As an example, and with reference to the cable clasping device 800′ of FIGS. 10A through 10D, the corresponding mounting system (for example, a mounting system 808′) occupies or encompasses a shorter or a smaller area at the second axial end surface 832 of the body 804. In other words, the mounting system 808′ or the corresponding suction member (for example, the suction member 880′) need not necessarily encompass an entirety of the second axial end surface 832 of the body 804 of the cable clasping device 800′. Several other parts and element of the cable clasping device 800′ can remain the same as with the cable clasping device 800, but they are not annotated and/or described again for brevity.

It can be noted that FIGS. 10A through 10D also illustrate an exemplary process by which the section 102 of the cable 104 can be received, accommodated, and routed through the body 804 of the cable clasping device 800′. It can also be noted that the manner of use or operation to accommodate the section 102 of the cable 104 within the body 804 of the cable clasping device 800′ remains similar to the functionality discussed for the cable clasping device 100, 100′, and the same is also applicable for the cable clasping device 800 described in FIGS. 8A through 9B. The process can exemplarily include—opening the gate portion 860 to an opened state (see FIG. 10A); accessing the section 102 of the cable 104 and inserting the section 102 of the cable 104 into the indentation 840 (see FIGS. 10B and 10C in conjunction); and closing the gate portion 860 to the closed state (see FIG. 10D) so as to enclose the section 102 of the cable 104 within the body 804.

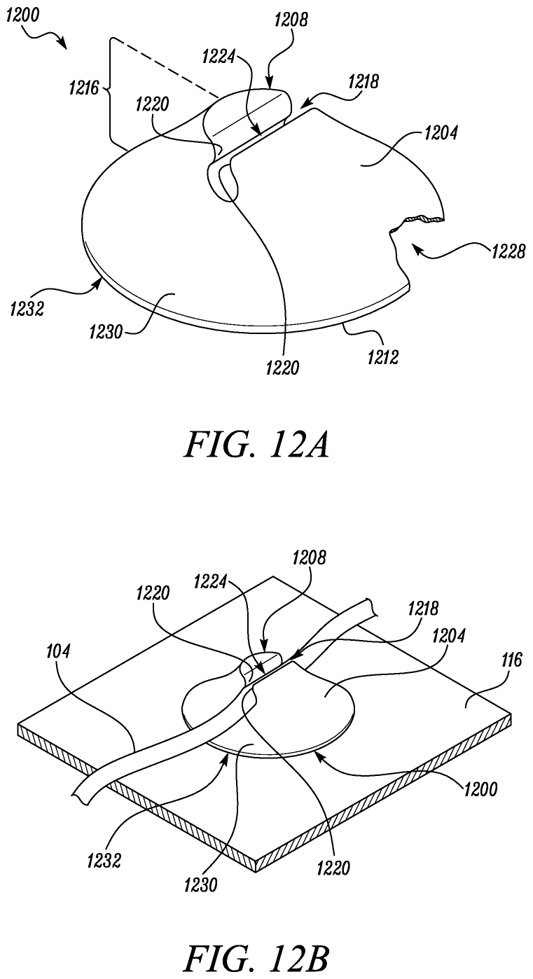

Referring now to FIGS. 12A and 12B, yet another embodiment of the cable clasping device 100, 100′, 800, 800′, as a cable clasping device 1200, is illustrated. The cable clasping device 1200 is devoid of a gate portion (for example, the gate portion 860) and thus is made more sleeker and more compact so as to possess a comparatively reduced size and/or bulk and be even more easily portable in comparison to the cable clasping devices 100, 100′, 800, 800′, described above. The cable clasping device 1200 exemplarily includes a body 1204 defining an apex portion 1208, a base portion 1212, and a conical portion 1216 extending from the apex portion 1208 to the base portion 1212.

The apex portion 1208 defines an indentation 1218. The indentation 1218 can be similar to the indentation 840 described for the body 804 of the cable clasping device 800, 800′, and thus can include one or more of the features described for the indentation 840 of the cable clasping device 800, 800′, such as the flexible lips 852 and the mouth 848, correspondingly as flexible lips 1220 and mouth 1224, as shown. According to an example, the conical portion 1216 is integrally formed with the indentation 1218. Moreover, the conical portion 1216 is flexible and defines a hollow 1228 (see hollow 1228 marked through a cut-out provided in FIG. 12A). The hollow 1228 exemplarily starts from the base portion 1212 and extends towards the apex portion 1208. With the configuration of the conical portion 1216 and the base portion 1212, in conjunction with the hollow 1228, as described above, it will be appreciated that the conical portion 1216 is usable as a suction member 1230 and thus forms part of an exemplary mounting system 1232 for the cable clasping device 1200. Although not limited, the body 1204 of the cable clasping device 1200 can be made from a polymeric material.

When using any one of the cable clasping devices 800, 800′, 1200, it will be appreciated that to route the section 102 of the cable 104 through the corresponding body 132, 132′, 804, 1204, the section 102 of the cable 104 is pressed into the indentation 840, 1218 causing the section 104 of the cable 104 to be snapped into the indentation 840, 1218 to be accommodated within the body 132, 132′, 804, 1204. In process of doing so, a corresponding pressing action imputed to the section 102 of the cable 104 is also imputed to the one or more suction members 880, 880′, 1230 of the mounting system 808, 808′, 1232 such that the suction members 880, 880′, 1230 can be pushed against a surface (for example, the working surface 116) and be secured thereto by way of the suction force.

The aforementioned embodiments of the cable clasping devices 100, 100′, 800, 800′, 1200 are not an exhaustive list of embodiments. Various additional options and features, alterations, and customizations in profile shape and silhouette of one or more parts of the cable clasping devices 100, 100′, 800, 800′, 1200, can be contemplated. Further, someone skilled in the art can also contemplate cable clasping devices with an absence or omission of one or more of the features described above for the cable clasping devices 100, 100′, 800, 800′, 1200. Such contemplation can be based on the description provided in the present description, but without departure from the claimed subject matter.

Based on the description above, it will be appreciated that the cable clasping devices 100, 100′ ensure that cables 104, 104′ extending from apparatuses 108, 108′ are securely retained at a user desired position on a surface. Also, the cable clasping devices 100, 100′ prevent displacement of the cables 104, 104′ and damage that can occur to the apparatuses 108, 108′ when distal cable portions 124, 124′ are disturbed or mishandled. It will be also understood that the cable clasping devices 100, 100′ can be applied to receive a variety of other elongated articles or elongated items that are similar in shape and/or profile to a cable, such as a lanyard, a rope, a cord, a string, and the like. Accordingly, it will be understood that the applications of the cable clasping devices 100, 100′ along with the apparatuses 108, 108′ described herein are purely exemplary.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the description. This method is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A cable clasping device, comprising:
a body defining an outer surface, a first end face, a second end face, and one or more retention structures configured to receive a section of a cable to retentively secure the section of the cable with respect to the body, the one or more retention structures defining an indentation extending into a thickness of the body from the outer surface and spanning between the first end face and the second end face to facilitate the section of the cable to be accommodated and routed through the body; and
a mounting system configured to mount the body against a surface to retain the section of the cable against the surface.

2. The cable clasping device of claim 1, wherein the mounting system includes a plate and one or more fasteners, the plate being coupled to the body and the one or more fasteners being drivable through each of the plate and the surface to retain the body fixedly against the surface.

3. The cable clasping device of claim 1, wherein the mounting system includes one or more suction members, the one or more suction members being coupled to the body and engageable with the surface by an application of a suction force to retain the body removably against the surface.

4. The cable clasping device of claim 3, wherein the mounting system includes a lever movable to a first position and to a second position, wherein,
in the first position, the lever applies the suction force, and in the second position, the lever releases the suction force.

5. The cable clasping device of claim 3, wherein to route the section of the cable through the body, the cable is pressed into the indentation and a corresponding pressing action imputed to the section of the cable to accommodate and route the section of the cable through the body is also imputed to the one or more suction members such that the one or more suction members are pushed against the surface and secured thereto by the suction force.

6. The cable clasping device of claim 1, wherein the indentation spans between the first end face and the second end face along a linear pathway.

7. The cable clasping device of claim 1, wherein the indentation spans between the first end face and the second end face along a non-linear pathway.

8. The cable clasping device of claim 7, wherein the non-linear pathway includes one or more of a zig-zag pathway, a serpentine shaped pathway, an S-shaped pathway, and an irregular pathway.

9. The cable clasping device of claim 7, wherein the non-linear pathway enables the section of the cable to acquire one or more bends when the section of the cable is received into the non-linear pathway, the one or more bends causing the section of the cable to be retentively secured and locked with respect to the body.

10. The cable clasping device of claim 1, wherein the indentation defines a friction surface to engage the section of the cable by frictional force and impede a motion of the section of the cable with respect to the one or more retention structures.

11. The cable clasping device of claim 1, wherein the first end face and the second end face are located opposite to each other about the body.

12. The cable clasping device of claim 1, wherein the body defines a base portion having a first surface and a second surface opposite to the first surface, the indentation being arranged on the first surface and the mounting system being arranged on the second surface.

13. The cable clasping device of claim 1 further including a gate portion pivotably coupled to the body to be moved to enclose the section of the cable.

14. The cable clasping device of claim 13, wherein the gate portion includes an underside directed towards the body, the cable clasping device further including a securing structure coupled to the gate portion to secure the cable within the cable clasping device when the gate portion is moved to enclose the section of the cable.

15. The cable clasping device of claim 1, wherein the body defines a pair of flexible lips facing each other to shield the section of the cable from a disengagement from the indentation, and wherein the section of the cable is inserted through a clearance defined between the pair of flexible lips to enter and be accommodated into the indentation.

16. The cable clasping device of claim 1, wherein the body is made from a polymeric material.

17. The cable clasping device of claim 1, wherein the body defines one of a circular shape or an elliptical shape.

18. The cable clasping device of claim 17, wherein when the body includes the elliptical shape, the first end face and the second end face are located along a major axis defined by the elliptical shape.

19. The cable clasping device of claim 17, wherein when the body includes the circular shape, the first end face and the second end face are located along a diameter defined by the circular shape.

20. The cable clasping device of claim 1, wherein the indentation defines a first opening at the first end face to route in the cable into the indentation and a second opening at the second end face to route the section of the cable out of the indentation.

21. The cable clasping device of claim 1, wherein the indentation defines an inner surface configured to define an interference fit with the section of the cable.
